(19) United States
(12) Patent Application Publication
(10) Pub. No.: US 2006/0259342 A1
(43) Pub. Date: Nov. 16, 2006

(54) Rule based document distribution to partners

(76) Inventors: Bernhard Hartenstein, Angelbachtal (DE); Joerg Hofmann, Contwig (DE); Michelle Green, Bloomfield Hills, MI (US); Johannes Kreischer, St. Ingbert (DE); Wolfgang Gentes, Zweibruecken (DE); Carsten Lessmann, Bremen (DE)

Correspondence Address: KENYON & KENYON, 1500 K STREET N.W., WASHINGTON, DC, 20005, US

(21) Appl. No.: 11/198,305

(22) Filed: Aug. 8, 2005

Related U.S. Application Data
(60) Provisional application No. 60/680,009, filed on May 12, 2005.

(51) Int. Cl. G06Q 99/00; G06F 9/46; G06F 15/02

(52) U.S. Cl. 705/9; 705/1

(57) ABSTRACT

An automated lead distribution system for Customer Relation Management (CRM) performs automatic distribution of business leads based upon a set of rules. A comparison is made between parameter data of a business lead and a series of criteria which must be met to satisfy a rule. If the series of criteria of a rule are satisfied, instructions associated with the rule are executed to select at least one partner from a qualifying group to receive the business lead. A distribution algorithm is applied to balance a number of leads assigned to each partner. Automating the lead distribution process decreases the amount of manual intervention and channel support costs involved in determining the “best” partner. The system may also provide support to a manager if manual intervention is required to assign a lead to a partner by proposing a subset of partners determined to be best suited for the work based on particular criteria.

Priority is claimed from U.S. Provisional Application No. 60/680,009 filed May 12, 2005, the contents of which are incorporated herein by reference.

### BACKGROUND

Companies are increasingly leveraging indirect sales through partners to reach new customers and to expand into new markets. As a result, one of the main focus areas for brand owners is to be able to collaborate with partners on new business leads and opportunities.

Brand owners can generate leads from multiple sources such as trade shows, the internet, marketing campaigns, or direct contact from customers. With all of these interactions, thousands of leads can be generated and it becomes very important for the brand owner to distribute these leads appropriately across a network of partners.

Lead processing traditionally has been a manual exercise. Shortcomings of the traditional processes for managing leads include:
inefficient and time consuming manual hand offs such as email, phone, fax, etc.;
poorly-selected assignments to partners such as when the assigning manager does not know sufficient details about a partner's qualifications or availability;
no visibility of the status once a lead is assigned;
the overloading of some partners and the underutilization of others; and
the requirement for manual follow-through.

With an increasing number of leads (e.g., thousands), traditional lead management processes become too labor intensive and expensive.

For companies to effectively manage leads, there is a need for a management system able to generate more qualified leads from the customers, buyers, resellers, distributors, and direct sales channels that buy and sell a business's goods or services (i.e., to generate more qualified leads throughout the demand chain), decrease channel support costs, automatically distribute those leads to the best partners with a minimum of manual intervention, track the progress of those leads, and then close the loop to ensure that the leads were acted on appropriately. Where manual intervention may be required, a manager needs to be able to easily identify a subset of partners best suited to work on a lead or opportunity.

### BRIEF DESCRIPTION OF THE DRAWINGS

FIG. 1 is a block diagram of an example system in accordance with the present invention.

FIG. 2 is an example flow chart illustrating the lead assignment process.

FIG. 3 illustrates an example Rule Set.

### DETAILED DESCRIPTION

An automated lead distribution system for Customer Relation Management (CRM) applies a rule-based system to automatically perform lead distribution. Other documents may also be distributed, such as activities and opportunities descriptions, sales orders, and tasks. Automating the document distribution process decreases the amount of manual intervention and channel support costs involved in determining the “best” partner.

The system may also provide support to a manager if manual intervention is required to assign a lead or other document to a partner by proposing a subset of partners determined to be best suited for the work based upon particular criteria.

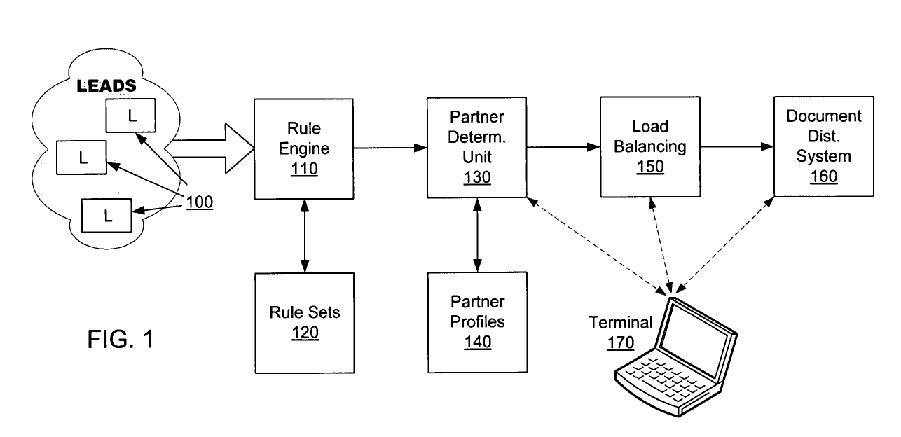

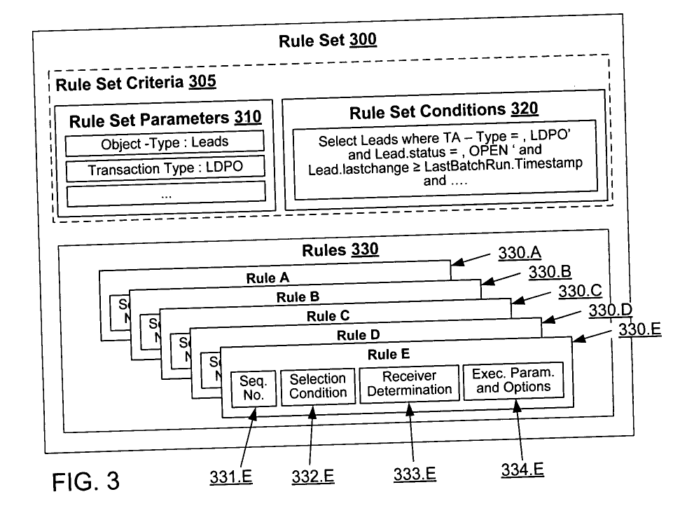

FIG. 1 illustrates an example of an automated lead distribution system. Each lead 100 is a data object that provides parameter data that is used for determining which lead should be dispatched to which partner. A rule engine 110 compares the content of each lead to a plurality of rule sets 120. The rule sets may be stored, among other ways, in a database. Each rule set 300 (FIG. 3) defines a series of criteria 305 (FIG. 3) that must be met by an incoming lead for a match to occur. If a lead 100 satisfies the series of criteria 305 of a rule set 300, a comparison is then made between the lead 100 and a plurality of rules 330 (FIG. 3) associated with the rule set 300. Rule sets 300 facilitate the assignment of only a subset of rules to a certain business process, simplifying rule maintenance, lowering processing time, and enabling assignment of different rule-set access privileges to different administrators. In comparison, prior conceptions required that all the rules be taken into account, with only a rule having its conditions satisfied to decide whether the rule is applicable in certain situation.

When a rule's conditions 332 (FIG. 3) are satisfied, the partner determination unit 130 performs a comparison between a rule's receiver determination criteria 333 (FIG. 3) and a plurality of partner profiles 140 to select a partner or partners. The partner profiles may be stored, among other ways, in a database. The partner determination unit 130 makes a preliminary assignment of the lead 100 to the selected partner, and load balancing unit 150 applies a distribution algorithm to balance the number of leads assigned to each partner. Thereafter, the document distribution system 160 distributes the lead 100 to the assigned partner (e.g., e-mail, groupware task, posting to a group worklist).

The document distribution system 160 may distribute the lead as, among other things, an object linking back to the originating system so that the status of the lead (e.g., partner action on the lead) can be accessed by a manager. The object may be a workflow object. Workflows automate business processes by integrating tasks across organizations, applications, and system boundaries. A workflow maps individual tasks needed to complete the workflow to users/groups, automatically informing users/groups of user of their role in the workflow and providing them with whatever information is required for the task. Workflows may include scheduling escalation procedures (e.g., adjust due dates; send reminders; reassign tasks) to assure that the workflow is completed in a timely manner. The workflow process creates a precise audit trail and can provide powerful analysis reporting to allow future optimization of the process.

The document distribution system 160 may also aggregate the distribution results and provide a summary which can be accessed later by a manager for review.

While load balancing in FIG. 1 is illustrated as appearing in the chain after the partner determination unit 130 preliminarily assigns the lead 100, a load balancing algorithm such as round-robin may be applied by the partner determination unit 130 when multiple partners qualify for a same lead, combining partnership determination with an aspect of load balancing.

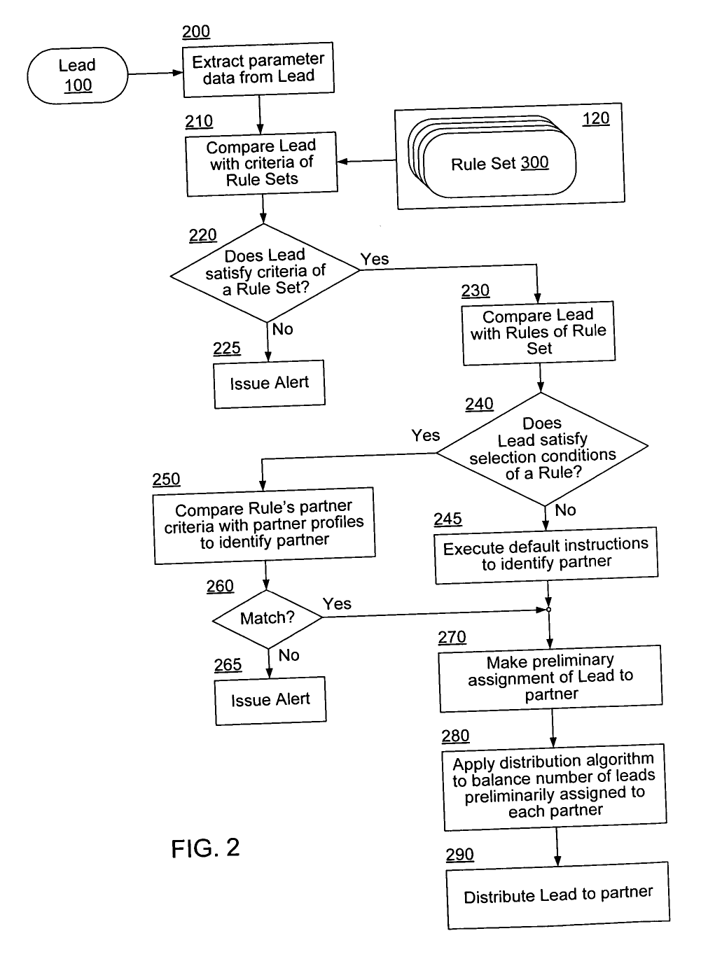

FIG. 2 is an example flow chart illustrating how the automated lead distribution system assigns and distributes leads. As an initial step, parameter data may be extracted (200) from a business lead 100. The parameter data in the lead may be in a format (e.g., XML) where the meaning behind information in the lead is readily identifiable, simplifying extraction of the parameter data. Similarly, the lead may comprise a form, where the parameter data is extracted from fields of the form. However, all or part of the lead may not be formatted (e.g., raw text), such that extraction may require parsing the document to identify content qualifying as parameter data (e.g., semantic analysis of the text, comparing features of the text against a knowledge base to discern meaning).

Responsive to receiving a document containing the business lead, the rule engine 110 compares (210) the parameter data of the lead 100 with the rule set conditions 320 of the rule sets 120. The comparison (210) may also compare the parameter data of the lead 100 with one or more rule set parameters 310 (FIG. 3) used to organize rule sets. The comparison (210) of the parameter data with the rule set parameters 310 and/or the rule set conditions 320 may be independent of any later selection process for individual rules 330, serving as a rule set pre-selection process. Since pre-selection of rule sets lowers the number of rules that must be compared, pre-selection enhances execution performance.

If the parameter data of the business lead 100 does not satisfy (220) any of the rule set conditions 320, the rule engine 110 may issue (225) an alert to a manager, soliciting human intervention into the lead assignment process. Otherwise, if the parameter data of the business lead 100 does satisfy (220) the rule set parameters conditions 320 of a rule set 300 (and/or match the rule set parameters 310), the parameter data of the business lead is compared (230) with the rules 330 of the rule set 300.

If the parameter data of the business lead 100 does not satisfy (240) the conditions 332 of any of the rules 330, the partner determination unit 130 may execute (245) default instructions to identify a partner to receive the business lead. Otherwise, if the parameter data of the business lead 100 does satisfy (240) the conditions 332 of one of the rules 330, the partner determination unit 130 compares the receiver determination criteria 333 associated with the rule 300 with a plurality of partner profiles 140 to identify (250) at least one partner to receive the business lead. If no match is found (260), the partner determination unit 130 may issue (265) an alert to a manager, soliciting human intervention into the lead assignment process. If a partner or group of partners are identified for the business lead, a preliminary assignment (270) is made to the partner or partner group.

A load balancing unit 150 applies a distribution algorithm to balance (280) the number of leads preliminarily assigned to each partner. As an example of load balancing, the partners may be prioritized by partnership levels and the parameter data of the lead may include an attribute corresponding to an importance of the lead. The distribution algorithm may balance the number of documents assigned to each partner by shifting excess documents of higher importance to partners in higher partnership levels, and shifting excess documents of lower importance to partners in lower partnership levels. As a further example, leads may relate to a product or service, and the partnership levels assigned to the partners may be indexed according to the product or service, such that the identity of the product or service may be relevant to load balancing. The partnership level assigned to a respective partner may correspond to a value assigned to the partner by a supplier of the product or service.

After load balancing, the document distribution system 160 distributes (290) the lead to the partner.

At various stages of the process, such as after preliminary assignments (270) of leads to partners, or after the load balancing algorithm is applied (280), information may be displayed on a user interface of a terminal 170 to prompt a manager to review and/or adjust the assignments. The outputting of this information may be handled by, for example, the partner determination unit 130, the load balancing unit 150, and/or the document distribution system 160. If multiple partners may qualify for a lead, the user interface may also provide the manager with a subset of other partners that are best qualified for a particular lead. Similarly, when an alert is issued (225, 265), a manager may be provided options to assign the lead via the user interface of the terminal 170. The manager's user interface may include, for example, a graphical or text-driven display and one or more input devices such as a keyboard and a pointing device (e.g., mouse, trackpad, trackball).

FIG. 3 illustrates an example rule set 300. Each rule set 300 may include criteria 305 comprising rule set parameters 310 and rules set conditions 320. Rule set parameters provide generic selection restrictions, containing information such as a rule set identifier, the related object type (e.g., document types to be handled by the rule set, such as lead, opportunity, etc.), the transaction type, a release status (e.g., “blocked” if rule set undergoing maintenance, “released” if active), a validity period (e.g., for preparation of territory or organizational structure reforms), and an update list (e.g., status, error status, partner function). Rule set parameters 310 may be used to organize the rule sets, and may be used with the rule set conditions 320 by the rule engine 110 to filter which rule sets will be compared to the lead 100. By associating a single set of rule set parameters 310 with a plurality of distribution rules 330, the rule set parameters 310 may simplify the number of comparisons needed to determine whether a lead 100 matches a particular distribution rule. This hierarchical rule structure also enables a manager to structure a rule set 300 for particular requirements, to sequence the distribution rules 330 independent from the sequence in other rule sets, to more easily maintain the rules, and to more easily obtain an overview of the rules in each set.

The rule set conditions 320 contain the main selection criteria that are valid for each lead that should be distributed by the assigned rule set. Whereas the rule set parameters 310 may comprise generic attributes to be used as criteria, the rule set conditions 320 may include logical and Boolean criteria, which may (in part) refer back to the rule set parameters 310. The use of rule set conditions 320 under which rules 330 are grouped allows a manager developing rules to focus on the particular distribution requirements for each rule 330, independent from the generic selection restrictions defined by the rule set conditions 320, such as limits on which geographic regions are under a manager's control.

The system may provide different levels of access protection to the rule set parameters 310, the rule set conditions 320, and the rules 330. For example, administrator rights may be required to modify the rule set parameters 310 and rule set conditions 320, while allowing an assigned manager to modify the rules 330. The particular levels of protection afforded to each component of the rule set 300 may be specified as one or more of the rule set parameters, or may be set as a separate system configuration.

Each rule set includes a plurality of distribution rules (e.g., 330.A through 330.E) related to a same object and transaction type. Each rule may have a sequence number 331 to define the correct order of the execution of the rules. Based on this number, the documen-related selection conditions 332 will be checked in numerical order. This indexing enables the rules to be structured from the specific ones to the more generic rules, such that it may not be necessary to exclude overlapping selection conditions 332. When a lead 100 is compared against the business rules, the first rule in which the selection condition criteria 332 are met may be used to determine the partner. Therefore, it is the responsibility of the manager to create rules which are sequenced from specific to general so that the most appropriate rule is taken into account.

The comparison of content between a rule 330 and a lead 100 may include a comparison of standard lead parameter data and other information contained in a lead with selection conditions 332. These selection conditions 332 may include, for example, product/product category of interest, lead origin, lead importance, marketing attributes, address information or geographical location of the customer/prospect, and the like.

A rule 300 may also include a receiver determination 333 to define the criteria for selecting the best suited partner. Examples of the receiver determination criteria may include a partner's geographical location, the products/product categories the partner sells, the partner type, the partner's program (e.g., a sales program), the partner's status, the partner's qualifications, the partner's certifications, marketing attributes, and whether there is an existing relationship between the partner and a specified list of customers.

Based on this receiver determination 333, the partner determination unit 130 will find a matching partner. The receiver determination 333 may be executed independent from any selection condition 332. If no partner can be found, an alternative receiver determination (e.g., a default) may be possible such as, for example, if a particular partner could not be found in the region of the sales prospect, partners in the whole country could be searched.

Each rule 300 may also include execution parameters and options 334. Examples include whether only a single partner should be found, whether a particular type of load balancing should be applied (e.g., round robin, or preliminarily assigning each lead to all matching receivers/partners) when the partner determination unit 130 assigns the lead, arbitrary document updates responsive to preconditions for each update such as whether the partner function defined by the selection condition 332 should be updated with the found partner (e.g., if no partner was found for the geographic region and default instructions were instead used, updating the selection condition 332 to reflect the geographic region of the partner found by the default instruction), and whether an assignment should be regarded as a proposal that may be reviewed by a manager or should be dispatched automatically without review.

Although the above examples describe distribution of a business lead, these examples also extend to other types of documents associated with customer relationship management (CRM). For example, the document may related to an activity, opportunity, a sales order, or a task.

The various components 110 to 160 illustrated in FIG. 1 may me implemented as one or more processes on one or more computer systems. Each computer system may include a storage component for storing machine-readable instructions for performing the various processes described above. The storage component may be any type of machine readable medium (i.e., one capable of being read by a machine) such as a compact disk, hard drive memory, flash memory, floppy disk memory, DVD-ROM, CD-ROM or any type of machine readable (computer readable) storing medium. Each may also include addressable memory (e.g., random access memory, cache memory) to store data and/or sets of instructions that may be included within, or be generated by, the machine-readable instructions when they are executed by a processor on the respective platform.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method comprising:
comparing parameter data included in a data object with a plurality of rules, each rule comprising a first set of criteria specific to that rule;
if the first criteria of a rule are satisfied, comparing a second set of criteria associated with the rule against a plurality of partner profiles to identify at least one partner to receive the data object, making a preliminary assignment of the data object to said at least one partner;
applying a distribution algorithm to balance a number of data objects preliminarily assigned to each partner; and
distributing the data object to the assigned partner.

2. The method of claim 1, further comprising:
prior to comparing parameter data of the data object with the plurality of rules, comparing the parameter data with a third set of criteria of a rule set of a plurality of rule sets, said rule set further comprising said plurality of rules which each share the third set of criteria.

3. The method of claim 2, wherein the plurality of rules within said rule set are prioritized, and the rules are compared with the parameter data in descending order of priority, comparison of the rules with the parameter data stopping when the first criteria of a rule are satisfied.

4. The method of claim 2, further comprising issuing an alert if no third criteria of any rule set of the plurality of rule sets are satisfied.

5. The method of claim 2, further comprising executing default instructions if the third criteria of said rule set are satisfied, but no first criteria of any rule of said rule set are satisfied.

6. The method of claim 1, further comprising issuing an alert if the comparison of the second set of criteria fails to match at least one partner profile.

7. The method of claim 1, further comprising parsing contents of the data object to extract the parameter data.

8. The method claim 1, wherein the data object comprises a form, the method further comprising extracting the parameter data from fields of the form.

9. The method of claim 1, wherein the partners are prioritized by partnership levels and the parameter data of the data object includes an attribute corresponding to an importance of the data object, the distribution algorithm balancing the number of data object assigned to each partner by shifting excess data objects of higher importance to partners in higher partnership levels, and shifting excess data objects of lower importance to partners in lower partnership levels.

10. The method of claim 9, wherein the data object relates to a product or service, and the partnership levels assigned to the partners are indexed according to the product or service, each assigned partnership level corresponding to a value assigned to the partner for that product or service.

11. The method of claim 9, wherein the data object is a customer relationship management object, the parameter data relating to a business lead, an activity, an opportunity, a sales order, or a task.

12. The method of claim 1, wherein the rule having the first criteria that are satisfied further comprises an execution parameter specifying whether the preliminary assignment of the data object should only be made to a single partner, said making the preliminary assignment of the data object to said at least one partner further comprising executing said execution parameter.

13. The method of claim 1, wherein the rule having the first criteria that are satisfied specifies a particular type of load balancing algorithm to be applied when making the preliminary assignment of the data object to at least one partner, said making the preliminary assignment further comprising applying the specified type of load balancing algorithm.

14. The method of claim 1, further comprising executing a default instruction to make the preliminary assignment of the data object to said at least one partner if the second set of criteria fails to match at least one partner profile,
wherein the rule having the first criteria that are satisfied further comprises an execution instruction indicating that the second set of criteria of the rule should be updated based upon said at least one partner found by the default instruction,
the method further comprising executing said execution instruction.

15. A machine-readable medium storing instructions adapted to be executed by a processor to perform a method comprising:
responsive to a document including parameter data, comparing the parameter data with a first set of criteria of a rule set of a plurality of rule sets, said rule set further comprising a plurality of rules;
if the parameter data satisfies the plurality of first criteria, comparing the parameter data with the plurality of rules, each rule comprising a second set of criteria specific to that rule;
if the second criteria of a rule are satisfied, comparing a third set of criteria associated with the rule against a plurality of partner profiles to identify at least one partner to receive the document, making a preliminary assignment of the document to said at least one partner;
applying a distribution algorithm to balance a number of documents preliminarily assigned to each partner; and
distributing the document to the assigned partner.

16. The machine-readable medium according to claim 15, wherein the plurality of rules within said rule set are prioritized, and the rules are compared with the parameter data in descending order of priority, comparison of the rules with the parameter data stopping when the second criteria of a rule are satisfied.

17. The machine-readable medium according to claim 15, the method further comprising issuing an alert if no first criteria of any rule set of the plurality of rule sets are satisfied.

18. The machine-readable medium according to claim 15, the method further comprising executing default instructions if the first criteria of said rule set are satisfied, but no second criteria of any rule of said rule set are satisfied.

19. The machine-readable medium according to claim 15, the method further comprising issuing an alert if the executed instructions fail to match the document with at least one partner.

20. The machine-readable medium according to claim 15, the method further comprising parsing contents of the document to extract the parameter data.

21. The machine-readable medium according to claim 15, wherein the document comprises a form, the method further comprising extracting the parameter data from fields of the form.

22. The machine-readable medium according to claim 15, wherein the partners are prioritized by partnership levels and the parameter data of the document includes an attribute corresponding to an importance of the document, the distribution algorithm balancing the number of documents to each partner by shifting excess documents of higher importance to partners in higher partnership levels, and shifting excess documents of lower importance to partners in lower partnership levels.

23. The machine-readable medium according to claim 22, wherein the document relates to a product or service, and the partnership levels assigned to the partners are indexed according to the product or service, each assigned partnership level corresponding to a value assigned to the partner for that product or service.

24. A system comprising:
a first database storing a plurality of rule sets, each rule set comprising a first set of criteria and a plurality of rules, each rule comprising a second set of criteria;
a second database storing a plurality of partner profiles;
first means for selecting a rule by comparing parameter data of a document with the first criteria of a rule set stored in the first database, and if the parameter data satisfies the first criteria, comparing the parameter data with the second criteria of rules of the rule set;
second means for comparing a third set of criteria associated with the rule selected by the first means against the plurality of partner profiles in the second database to identify at least one partner to receive the document, and making a preliminary assignment of the document to said at least one partner;
third means for applying a distribution algorithm to balance a number of documents preliminarily assigned by the second means to each partner; and
fourth means for distributing the document to the assigned partner.

25. The system of claim 24, wherein prior to said fourth means distributing the document to the assigned partner, at least one of said second means, third means, and fourth means outputs a list of document assignments.

26. The system of claim 24, wherein the fourth means, when distributing the document to the assigned partner, links the document back to said system, the link providing a status of the document.
